(19) United States
(12) Patent Application Publication
(10) Pub. No.: US 2008/0319803 A1
(43) Pub. Date: Dec. 25, 2008

(54) METHOD AND SYSTEM FOR BOOKING TRAVEL PRODUCTS ONLINE ON THE BASIS OF UP-TO-DATE AVAILABILITY DATA DISPLAYED ON A MAP-BASED CLIENT INTERFACE

(75) Inventors: Jean-Noel Heyraud, Valbonne (FR); Wilfrid Johnston, Paris (FR); Tran-Dzien Nguyen, La Cannet (FR)

Correspondence Address: YOUNG & THOMPSON, 209 Madison Street, Suite 500, ALEXANDRIA, VA, 22314, US

(73) Assignee: AMADEUS S.A.S., BIOT (FR)

(21) Appl. No.: 11/765,509

(22) Filed: Jun. 20, 2007

(51) Int. Cl. G06Q 50/00

(52) U.S. Cl. 705/5

(57) ABSTRACT

A method for booking or checking or saving travel products from a travel service provider operating over a network and having at least one server running a travel application delivering map-based interface web pages to at least one client applications, the method, includes:
receiving a request from a client application including a defined geographic area;
determining what travel products are potentially available in the defined area;
putting together a map of the geographic area;
embedding in the map the positions of the potentially available travel products;
retrieving from the server database static data corresponding to the potentially available travel products within the defined area;
fetching from a global distribution system real-time data related to the potentially available travel products within the defined area;
merging the map, static data and real-time data in a map-based interface web page;
forwarding web page in response to the client's request.
proceeding with booking, checking or saving of one of the travel products on the basis of its location on the map, contents of the static and real-time data.

### FIELD OF THE INVENTION

The present invention relates generally to online checking and booking of travel products and services and more specifically refers to a system and a method to display only those of the products and services that are still actually available at booking time in order to expedite the travel transactions initiated by remote end-users of online travel service providers.

### BACKGROUND OF THE INVENTION

Online travel service providers are now deploying very sophisticated web sites in an attempt to attract more customers by greatly facilitating the process of checking or booking or saving a travel product such as a hotel room or a rental car. The most elaborated of these web sites manage to forward to their end-users maps of the area where travel products of interest are located. In practice, upon receiving specific requests issued from the end-users, server(s) of the web site respond by putting together and forwarding corresponding web pages to the client software applications, i.e., the web browsers or navigators running on any form of personal computer or computerized device owned by the end-users. Those web pages contain maps on which the locations of the travel products are clearly marked in their environment. Typically, traditional 2D (2-dimensional) maps of a particular geographic area of interest are forwarded which are very convenient to help end-user making a choice. Hence, end-user can view, e.g., part of a town where he/she would like to book a hotel room. Icons pinpoint precisely all hotel locations of the displayed area and, by clicking on the corresponding icons, he/she can obtain more information on the selected travel product. For hotel rooms this generally includes a small picture of the hotel, the mailing address, phone numbers and distances, e.g., to airports, train stations and local tourist attractions, along with the type of rooms and the range of prices. Also, a link to book the room is provided which, if clicked, will redirect the end-user to an independent online booking application possibly run by a third party hotel chain or travel service provider.

If the above seems very useful it fails however meeting an important implicit expectation of any end-user of a travel site desiring to book a room, or any other travel product, which is to know what is the actual current booking status of the travel product he/she is interested in. Indeed, all the information displayed by those sites contains only static information or, at best, information updated once in a while. If part of the provided information does not certainly need to be frequently updated or updated at all (address, room descriptions, distances to points of interest, etc) the remaining part on room availabilities and corresponding prices is possibly changing any time. It is of no use to the end-user of knowing that a certain category of rooms is offered at a certain price in a hotel if anyway they are already sold out when he/she connects to the site of the travel service provider.

Accordingly, there is a need for a system and a method that provides the actual availability of travel products when they appear on the map of the geographic area from where end-user of an online travel service provider is expecting to find a travel product to book.

### SUMMARY OF THE INVENTION

The present invention meets the above need and describes a method for booking or checking or saving travel products from a travel service provider operating over a network and comprising at least one server running a travel application, the travel application delivering map-based interface web pages to at least one client applications, the method, comprising the steps in destination of:
receiving a request from a client application including a definition of a geographic area at the travel application;
determining what travel products are potentially available in the defined geographic area;
putting together a map of the geographic area; further including the step of:
embedding in the map the positions of the potentially available travel products;
retrieving from the at least one server database static data corresponding to the potentially available travel products within the defined geographic area;
fetching from a global distribution system (GDS) real-time data related to the potentially available travel products within the defined geographic area;
merging the map, the static data and the real-time data in a map-based interface web page;
forwarding said web page in response to the client application having issued the request.
proceeding on client side with booking, checking or saving of one of the travel products on the basis of its location on the map, contents of the static data and contents of real-time data.

It is therefore an object of the present invention to display on a map-based interface of a travel client software application up-to-date data, retrieved in real time from a GDS, to ease checking, saving or booking of the offered travel products.

Further objects, features and advantages of the present invention will become apparent to the ones skilled in the art upon examination of the following description in reference to the accompanying drawings. It is intended that any additional advantages be incorporated herein.

### BRIEF DESCRIPTION OF THE DRAWINGS

FIG. 1 shows a GUI, including a 3D map, of the kind considered by the invention.

FIG. 2 illustrates the environment in which invention is best operated and a GUI widget which, according to the invention, includes up-to-date availability data to expedite booking of travel products.

FIG. 3 shows a flow chart of the steps of the method for booking travel products.

### DETAILED DESCRIPTION

The following detailed description of the invention refers to the accompanying drawings.

In the present invention, a travel product designates any product or service that can be supplied by a travel provider. Thus, travel products may relate for instance to hotel room, rental car, show seat, theatre seat, concert seat, event seat, museum ticket etc.

In the present invention, static data comprise for example name, address (141), phone number, amenities (143), user rating information, language spoken, industry rating and picture (145) of the hotel or of the rental car agent or of the theatre or of the museum providing the travel product.

In the present invention, real-time data may comprise updated availability and actual available prices (142, 146) of the travel product. Real-time data may also comprise program and special event if travel product relates to show, theatre or event seat, or museum ticket.

The following description provides an example of the invention wherein travel products relate to hotel rooms.

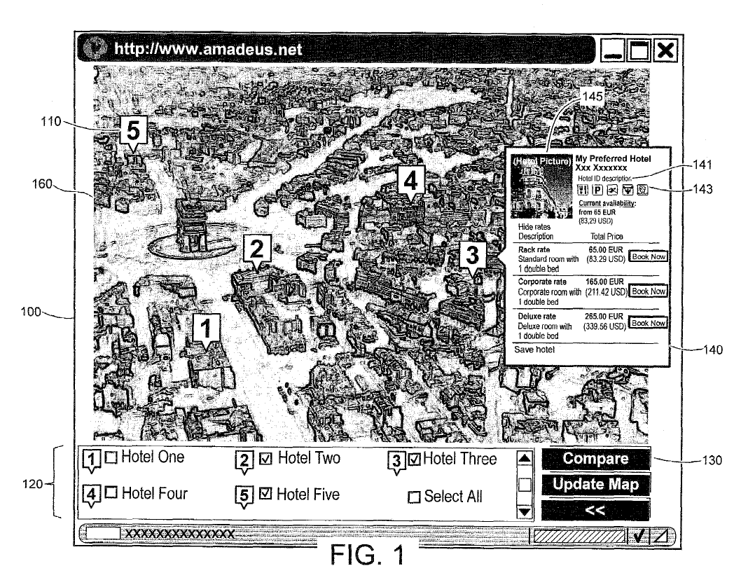

FIG. 1 shows a GUI (graphical user interface) window (100) as displayed by web browsers of online applications including a 3D map (160) of the kind considered by the invention. The specific travel products looked for by the end-user of an online travel service provider are then displayed over the map (160). This is achieved by the software application run on the web server possibly in cooperation with any third-party specialized mapping software. The map covers a geographic area as defined in the end user request. Map (160) is generally centered on an address or geographic position provided in the initial request with a defined level of magnification. Address can be anything ranging from the name of, e.g., a country, a town, a landmark, a postal address, a zip code, an airport, a train station, etc. The map (160) currently displayed on the GUI window (100) may also be obtained by sliding a previous map.

In this example where travel product looked for by the end-user is a hotel room, five numbered icons (110) pinpoint the five hotels found in the displayed area. Hotel names are also listed in list box (120) below from where they can be individually selected so that a comparison can be further requested (130). Upon selection of a given travel product from the list box (120), the icon representing said given travel product on the map is shown or removed. Icons are all individually selectable so that a pop-up window appears with all the necessary information regarding the selected hotel. Depending on the application, pop up window (140) also referred to as a widget, may appear either after clicking on the corresponding icon or just because it is a spring-loaded dialog box that automatically pops up when cursor is brought over the icon.

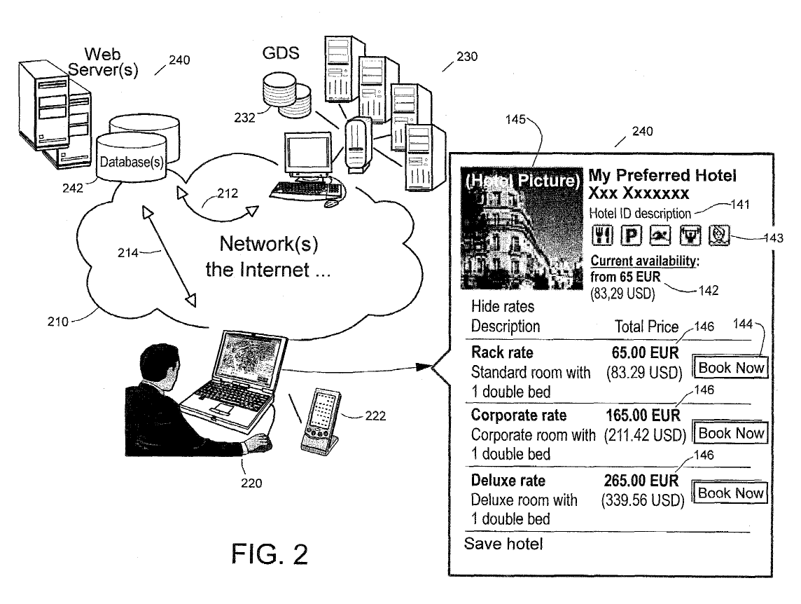

Whichever standard GUI technique is used to obtain this result, widget contains, as further discussed in FIG. 2, all the necessary information and graphic tools (e.g., buttons) to expedite booking of the corresponding hotel room if end-user decides to proceed.

FIG. 2 comprises a larger view of the exemplary widget (140) displayed over the map (160) when a particular icon (110) is selected. On top of the standard static information a travel service provider may want to display information to advertise its products (e.g., marketing text, small picture of the hotel, address, telephone numbers, etc). A widget according to the invention shows what the current actual availability of the travel product is. Hence, in this widget used to illustrate the invention, the lowest fare for a room still currently available in selected hotel is displayed (142). End-user of the travel application, being sure of the availability of the travel product he/she interested in, can thus proceed immediately to the booking (144).

To achieve the above objective the entity managing the booking of the travel products must be consulted in real time. Booking management is generally performed by one of the few global distribution systems (GDS's), such as AMADEUS, a world-wide service provider for the travel industry, on behalf of the business organization or company owner of the travel products. GDS's (230) have very large reliable computing and storing resources to serve the travel industry in a 24-hour a day 7-day a week mode. GDS's manage and keep updated numerous databases (232) of fares, availabilities, etc, on behalf of their client in order to process end-user requests. GDS resources are made accessible from all over the world through a combination of private and public networks including the Internet (210). Hence, the online travel service provider selling travel products from web sites (240) can always interrogate GDS (212) on their actual availability whenever end-user (220) is displaying widgets during a session (214) established between the travel software application and the browser running on end-user PC (220) or on any other computer-like communication device such as a personal digital assistant (PDA) capable of connecting to the Internet and having sufficient display capabilities (224). Typically, the static information appearing in the widget is coming from the web server database(s) (242) were it might be occasionally updated when necessary. On the contrary, real-time data, e.g., current room availabilities and actual prices, are dynamically fetched from the GDS or from any other entity in charge of managing the booking of the travel products.

Optionally, when user is connecting to the web site of the travel service provider position of the initial map can be automatically derived from any position-aware device imbedded or connected to any of the end-user communication devices (220, 222) such as a GPS (global positioning system).

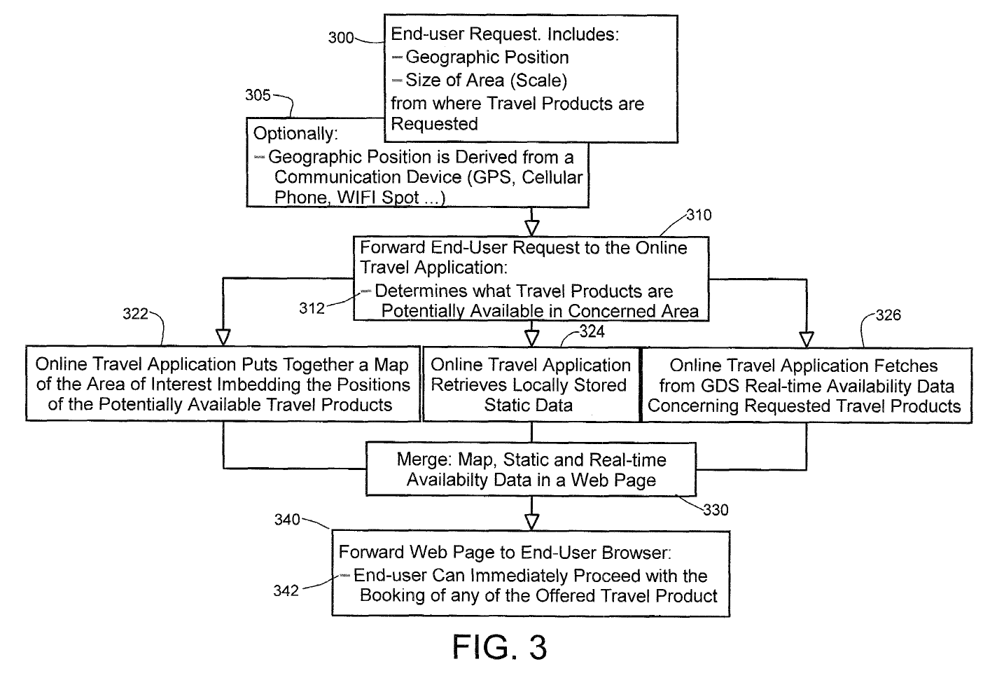

FIG. 3 is a flow chart of the actions taken place over a network between the web server on which travel application is running; the computer-like and communication device(s) running the client side application of the web session initiated by an end-user of the travel application; and the GDS aimed at providing in real-time to the web server up-to-date availability and price data corresponding to the travel products the end-user is looking for.

End-user performs the initial request after he/she has connected to an online web travel application for the purpose of checking or booking a particular travel product or service, e.g., a hotel room. The initial request (300) includes a geographic location from where product or service is expected to be delivered. Geographic location is entered by the end-user of the application as explained in FIG. 1.

Alternatively, end-user can be looking for travel products in the geographic area where he is currently present. In this case, coordinates of the current location can be optionally derived (305) from any GPS device imbedded or connected to the communication device from which web session is initiated. Geographic position of the end-user can be also optionally implicitly derived from other devices like a cellular phone by locating cell from which wireless communications are done or if end-user PC is connected to a WIFI spot, e.g., in an airport. Size of the geographic area to be considered highly depends on the type of request issued by the end-user. This may involve a whole country, a city, part of city, a small town, etc.

Once completed, request is forwarded (310) to the web server (240) handling the travel application which, for responding, must determine all the travel products potentially available in the geographic area (312). Travel application prepares a web page including any form of map that will typically display on end-user screen what is for example shown in FIG. 1. To this end, travel application needs to interrogate the concerned GDS (326) on the actual availability and price (142, 146) of the available travel products within the area. Static data (141, 143, 145) are retrieved from the database(s) (242) where they are locally stored (324). Building of the web page (100) also include preparing a map (160) for the scale and geographic location requested in the request and including all the travel products available in the displayed area (322). Map is possibly a 3D map as shown in FIG. 1, and is generally obtained in cooperation with any specialized third-party mapping service commercially available. Once real-time data, static data and map are obtained they are merged in the web page being built (330). When done, the web page is returned to the end-user (340). It thus contains not only the static information describing the travel product but also its current availability so that end-user can make immediately an informed decision and proceeds with the booking (342) of any of the travel products he/she offered.

In a particular embodiment, the retrieval of the static data is performed subsequently to the fetching of the real-time data. Further, only the static data corresponding to the travel products for which availability has been checked are retrieved from the server database.

When the user indicates an area through its request, either all the travel products located in this area may be considered to process the method, or only the travel products pertaining to specific types of travel products that have been selected by the user through its request may be considered for further processing.

The map-based interface of the present invention may include either 3D aerial-views of 2D views.

The invention also enables to display cross sell products such as hotel or car rental near to a given location (airport or train stations for instance).

A further feature of the invention relates to the possibility for a user to book-mark any product and to retrieve it outside of the booking session.

In a specific embodiment, the invention comprises a driving direction feature that enables the user to be provided with driving directions to reach a location corresponding to a selected travel product. For this purpose, an origin location must be provided to the application. The origin location may correspond to the current location of the user when this origin location can be derived from any position-aware device. In this case the current location is preferably automatically regarded as the origin location.

The destination location is provided by the user when selecting an icon on the map or a travel product on the list box or when activating a graphic tool (e.g. button) associated with a travel product.

While the description includes exemplary embodiments, other embodiments are possible, and changes may be made to the embodiments described without departing from the spirit and scope of the invention.

1. A method for booking or checking or saving travel products from a travel service provider operating over a network (210) and comprising at least one server (240) running a travel application, the travel application delivering map-based interface web pages to at least one client applications (220), the method, comprising the steps in destination of:
receiving a request from a client application (220) including a definition of a geographic area (300) at the travel application;
determining what travel products are potentially available in the defined geographic area (312);
putting together a map of the geographic area; further including the step of:
embedding in the map the positions of the potentially available travel products (322);
retrieving from at least one server database (242) static data (141, 143, 145) corresponding to the potentially available travel products within the defined geographic area (324);
fetching from a global distribution system (GDS) real-time data (142, 146) related to the potentially available travel products within the defined geographic area (326);
merging the map, the static data and the real-time data in a map-based interface web page (100, 330);
forwarding said web page (100, 330) in response to the client application having issued the request (340).

2. Method according to claim 1 comprising the further step of proceeding on client side with booking, checking or saving of one of the travel products on the basis of its location on the map, contents of the static data and contents of real-time data (342).

3. Method of claim 1 wherein only the travel products which are actually available are displayed on the map-based interface web page (100).

4. The method of claim 1 wherein the request comprises a selection of types of travel products to be booked, checked or saved, and the determination of travel products that are potentially available only concerns travel product types pertaining to said selection.

5. The method of claim 1 comprising the step of producing a display of the web page (100, 330) on client side and wherein:
the displayed travel products are listed in a list box (120) displayed along with the map, the static data and the real-time data,
some travel products of said list (100) are selected,
said selected travel products are further compared and/or displayed simultaneously on the map (110).

6. The method of claim 1 wherein the definition of a geographic area is derived from a position-aware device (305).

7. The method of claim 1 wherein the map-based interface includes 3D aerial-views of the defined geographic area (100).

8. The method of claim 1 wherein the travel product is a hotel room (240), or a show seat, or a theatre seat, or an event seat, or a rental car.

9. The method of claim 4 wherein the real-time data comprise actual availability data or actual prices (142, 146) regarding hotel room or show seat, or theatre seat, or event seat, or car rental.

10. The method of claim 1 wherein the static data and the real-time data corresponding to a specific travel product are displayed in a widget that pops up when the user clicks or brings a cursor over an icon of the map representing said specific travel related product.

11. A system for booking travel products from a travel service provider operating over a network (210) including communications means with at least a client application (220), the system comprising:
a web server (240) including computing resources and providing access to at least one data base (242) and to a GDS (230);
a computer program product stored on a readable storage medium of the computing resources comprising computer readable code means for causing at least one computer to operate the method for booking travel products on the basis of a map-based interface including up-to-date data according to claim 1.
